(19) United States
(12) Patent Application Publication
(10) Pub. No.: US 2024/0146979 A1
(43) Pub. Date: May 2, 2024

(54) SYSTEM, METHOD AND COMPUTER-READABLE MEDIUM FOR LIVE STREAMING RECOMMENDATION

(71) Applicant: 17LIVE Japan Inc., Tokyo (JP)

(72) Inventors: Arun RAWAL, Tokyo (JP); Sree LAKSHMI, Tokyo (JP); Nitin SRIVASTAVA, Tokyo (JP); Ajay Prakash MANGALE, Tokyo (JP); Abinash SEN, Tokyo (JP); Durgesh KUMAR, Tokyo (JP)

(21) Appl. No.: 18/348,102

(22) Filed: Jul. 6, 2023

(30) Foreign Application Priority Data
Nov. 1, 2022 (JP) 2022-175227

(51) Int. Cl. H04N 21/2187; H04N 21/24; H04N 21/258; H04N 21/4784; H04N 21/4788

(52) U.S. Cl. CPC H04N 21/2187; H04N 21/2407; H04N 21/25883; H04N 21/4784; H04N 21/4788

(57) ABSTRACT

The present disclosure relates to a system, a method and a computer-readable medium for recommending live streams. The method includes determining a user to be disengaged, determining a thumbnail of a live stream to be attractive for the user, determining the live stream to be attractive for the user, and displaying the thumbnail of the live stream to the user.

### CROSS-REFERENCE TO RELATED APPLICATIONS

This application is based on and claims the benefit of priority from Japanese Patent Application Serial No. 2022-175227 (filed on Nov. 1, 2022), the contents of which are hereby incorporated by reference in its entirety.

### TECHNICAL FIELD

The present disclosure relates to a terminal, a server, and a non-transitory computer-readable storage medium storing a program.

### BACKGROUND

Real time data on the Internet, such as live streaming programs, has become popular in our daily life. There are various platforms or providers providing the service of real time data accessing, and the competition is fierce. Therefore, it is important for a content provider to efficiently, precisely, and vibrantly recommend its users or viewers their desirable contents such that the viewers can stay on the platform as long as possible.

Japanese patent application publication JP2019-164617A discloses a system for recommending live videos to users.

### SUMMARY

A method according to one embodiment of the present disclosure is a method for recommending live streams being executed by one or a plurality of computers, and includes: determining a user to be disengaged, determining a thumbnail of a live stream to be attractive for the user, determining the live stream to be attractive for the user, and displaying the thumbnail of the live stream to the user.

A system according to one embodiment of the present disclosure is a system for recommending live streams that includes one or a plurality of processors, and the one or plurality of computer processors execute a machine-readable instruction to perform: determining a user to be disengaged, determining a thumbnail of a live stream to be attractive for the user, determining the live stream to be attractive for the user, and displaying the thumbnail of the live stream to the user.

A computer-readable medium according to one embodiment of the present disclosure is a non-transitory computer-readable medium including a program for recommending live streams, and the program causes one or a plurality of computers to execute: determining a user to be disengaged, determining a thumbnail of a live stream to be attractive for the user, determining the live stream to be attractive for the user, and displaying the thumbnail of the live stream to the user.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 is a data structure diagram showing an example of the thumbnail DB 336 of FIG. 3.

FIG. 8 shows an example of a stream selection screen with thumbnails displayed.

FIG. 9 shows an exemplary flow chart illustrating a method according to some embodiments of the present disclosure.

FIG. 10 shows an example of the ML model 350 in FIG. 3 according to some embodiments of the present disclosure.

FIG. 11 shows an exemplary recommendation method according to some embodiments of the present disclosure.

FIG. 12 shows examples of data structure for the classification results in FIG. 11.

FIG. 13 shows exemplary processes executed by the recommendation system in FIG. 11 according to some embodiments of the present disclosure.

FIG. 14 shows exemplary processes executed by the recommendation system in FIG. 11 according to some embodiments of the present disclosure.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

Conventional recommendation methods or systems for live streaming programs on the internet face several challenges that need to be addressed. For example, how to choose the thumbnails to be displayed to the viewers such that there is a higher probability for the viewer to click on a thumbnail to view the corresponding live streaming program. For example, how to achieve a higher retention rate or longer retention time once a viewer clicks into a live streaming program. Those challenges are even more difficult when the viewer is a new or disengaged viewer. That means the content provider or the platform does not have much information regarding the viewer.

The present disclosure provides systems or methods to improve the viewer click rate for thumbnails of live streaming programs. The present disclosure provides systems or methods to have a viewer stay longer in a live streaming program once he clicks into or enters the live streaming program.

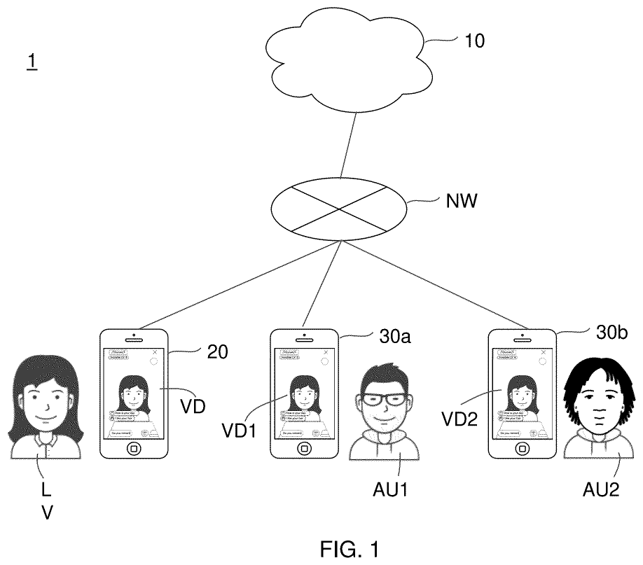

FIG. 1 shows a schematic configuration of a live streaming system 1 according to some embodiments of the present disclosure. The live streaming system 1 provides a live streaming service for the streaming streamer (could be referred to as liver, anchor, or distributor) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly to the server 1. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay even with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing, in other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

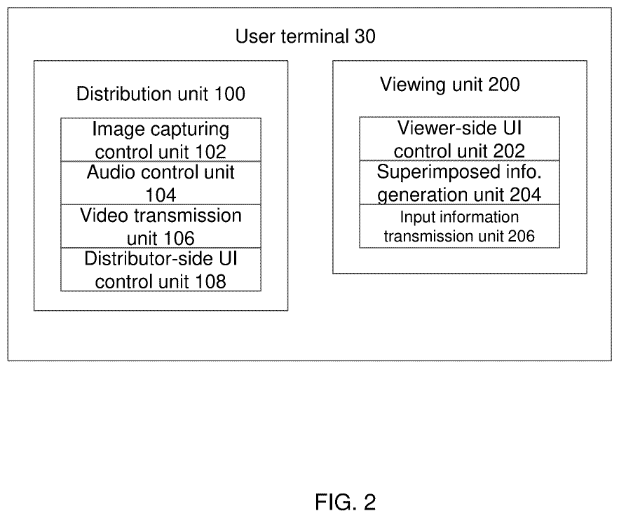

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30, These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distribution-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side UI control unit 108 controls an UI (user interface) for the distributor. The distribution-side UI control unit 108 is connected to a display (not shown in FIG. 2), and displays a video on the display by reproducing the video data that is to be transmitted by the video transmission unit 106. The distribution-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

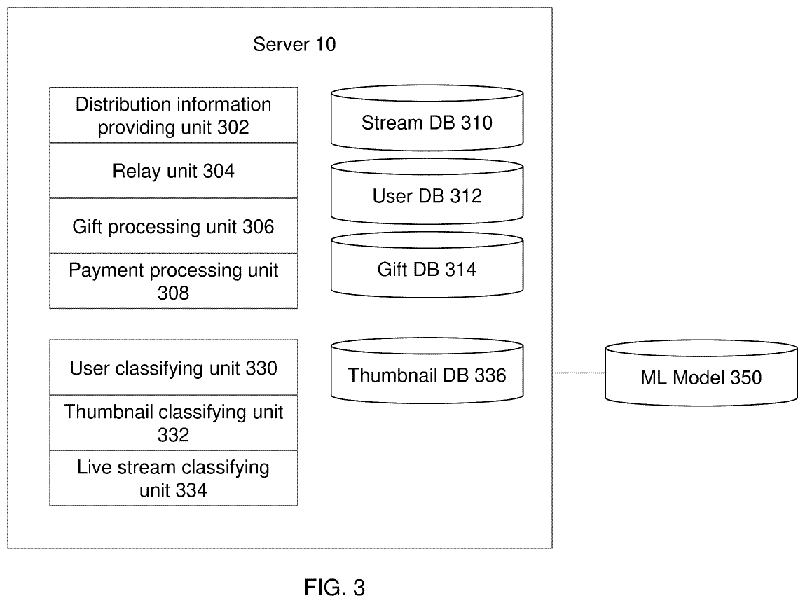

FIG. 3 shows a block diagram illustrating functions and configuration of the server of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, a user classifying unit 330, a thumbnail classifying unit 332, a live stream classifying unit 334, and a thumbnail DB 336. The server 10 communicates with a machine learning (ML) model 350. The ML model 350 could be a ML DB including one or more ML models.

Upon reception of a notification or a request from the user terminal 20 on the distributor side to start a live streaming (or live streaming program) over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewers selection result on the live stream selection screen, the input information transmission unit 206 generates a distribution request including the stream ID of the selected live stream, and transmits the request to the server 10 over the network NW, The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30, and the object specifying signal includes the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data, such as the object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to (or corresponding to) the points of the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

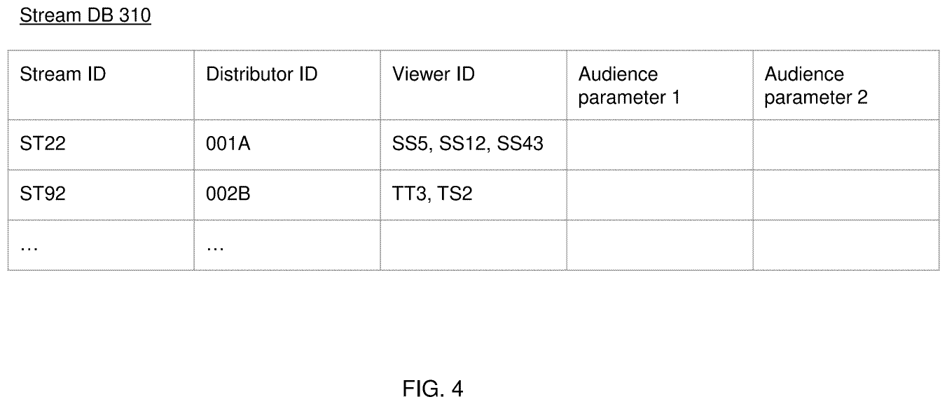

FIG. 4 is a data structure diagram of an example of the stream DB 310 of FIG. 3. The stream DB 310 holds information regarding a live stream (or a live streaming program) currently taking place. The stream DB 310 stores the stream ID, the distributor ID, the viewer ID, and one or more audience parameters (audience parameter 1, 2, . . . ), in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

Examples of the audience parameters may include: average number of comments per viewer in the live stream, average number of gifts per viewer in the live stream, average deposit amount per viewer in the live stream, and/or number of live viewers in the live stream. The audience parameters may be monitored or obtained by a monitoring unit (not shown in FIG. 3) within the server 10 or outside the server 10.

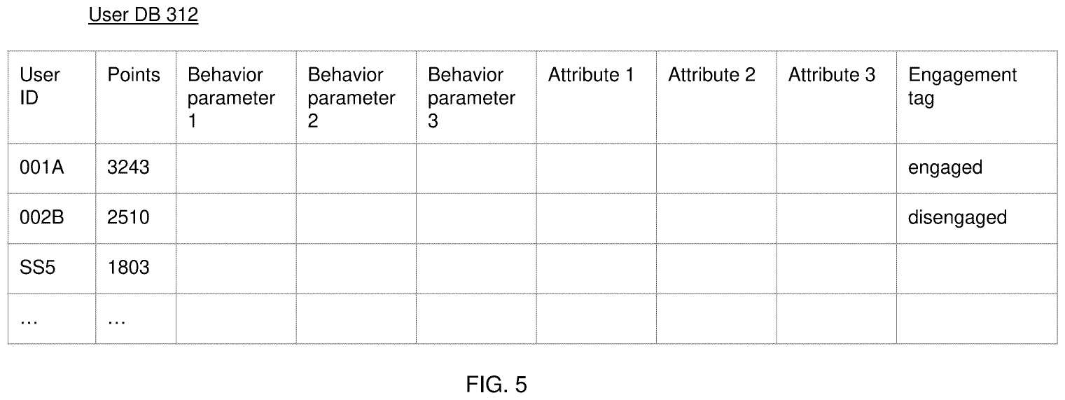

FIG. 5 is a data structure diagram showing an example of the user DB 312 of FIG. 3. The user DB 312 holds information regarding users. The user DB 312 stores the user ID, the point, one or more behavior parameters (behavior parameter 1, 2, . . . ), one or more attributes (attribute 1, 2, . . . ), and an engagement tag, in association with each other. Or, the user DB 312 stores pairs of user ID and points corresponding to each other. The user ID identifies a user. The point corresponds to the points the corresponding user has. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. Alternatively, when the distributor receives a gift from a viewer, the distributor may be given the amount of money corresponding to the gift instead of the points.

Examples of the behavior parameters may include: view frequency of the user on the platform, average view duration of the user (for example, per live stream) on the platform, average gift sending times of the user (for example, per live stream) on the platform, average number of comments of the user (for example, per live stream) on the platform, recency of the user on the platform, and/or engagement ratio of the user on the platform. The recency indicates how recently the user watches a stream on the platform. The recency could be defined to be the difference in number of days from the current date (calculating date) to the last watched stream date. A lower recency value may indicate the user is more active on the platform. The engagement ratio indicates how engaged the user is on the platform. The engagement ratio could be defined as: [number of engaged streams (for example, number of streams the user watched for more than 3 minutes)/total number of streams the user watched]. The behavior parameters may be monitored or obtained by a monitoring unit (not shown in FIG. 3) within the server 10 or outside the server 10.

Examples of the attributes may include: gender, nationality, hobby, blood type and/or zodiac sign of the user. Some attributes may be input from the user when registering at the platform. Some attributes, such as nationality, may be detected by a detecting unit (not shown in FIG. 3) within the server 10 or outside the server 10.

The engagement tag indicates if the corresponding user is classified as an engaged user or a disengaged user. The classification is done by the user classifying unit 330. The details will be explained later.

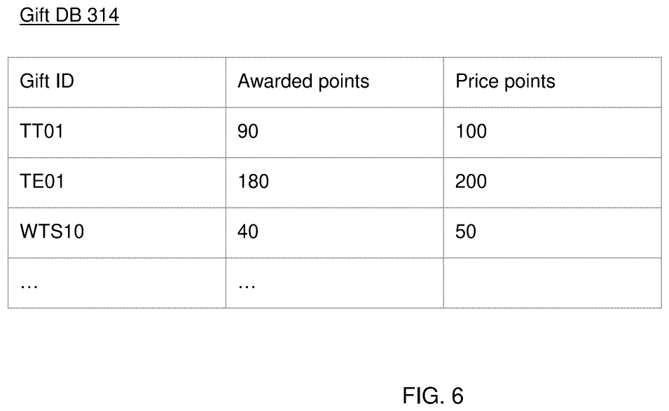

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points,

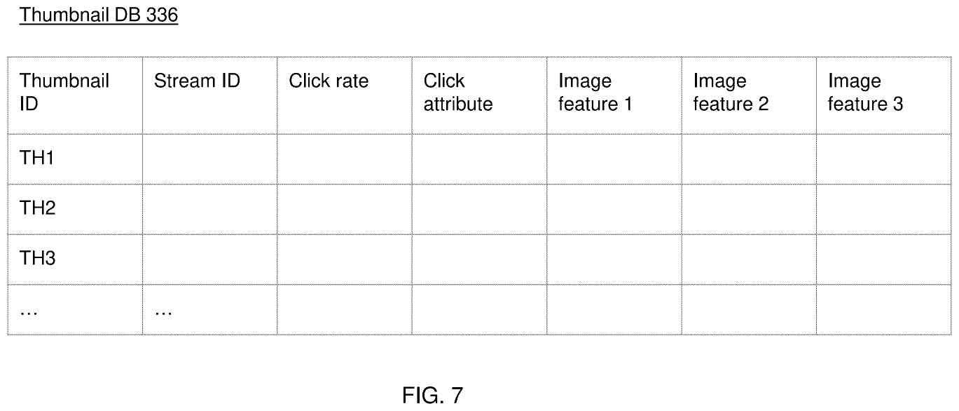

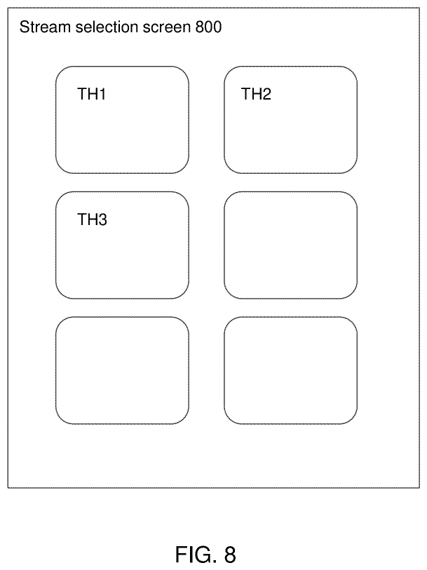

FIG. 7 is a data structure diagram showing an example of the thumbnail DB 336 of FIG. 3. FIG. 8 shows an example of a stream selection screen with thumbnails displayed.

As shown in FIG. 8, the stream selection screen 800 displays or includes several thumbnails (TH1, TH2, TH3, . . . ). Each thumbnail is a small picture or image, and corresponds to a stream (or live stream). The viewer may choose and click into one thumbnail to enter and enjoy the corresponding stream. The stream selection screen 800 may be a screen displayed on a display (such as a touch screen) of the user terminal 30.

As shown in FIG. 7, the thumbnail DB 336 stores the thumbnail ID, the stream ID, the click rate, the click attribute, and one or more image features. The thumbnail ID is for identifying a thumbnail. The stream ID is for identifying a stream that corresponds to the thumbnail.

The click rate indicates or reflects how likely the thumbnail is to be clicked by a user (or a viewer). For example, the click rate may be defined as [number of viewers who clicked into the thumbnail/total number of viewers who are presented with the thumbnail] in a time period. For example, if a thumbnail of a particular stream is recommended (or displayed, presented) to 100 viewers, wherein 10 viewers click the thumbnail to enter the stream, then the click rate will be 10/100=0.1.

The click attribute indicates or reflects the demography/details of the click rate. For example, the click attribute may include information regarding users who contributed to the click rate of a thumbnail. For example, the click attribute may include information regarding users who clicked into the corresponding thumbnail. From the click attribute, we can know the contribution (or contribution rate) from disengaged users or engaged users for the clicks of a thumbnail. In some embodiments, the click attribute may contain the attribute data and/or the engagement tag information of the users who clicked the corresponding thumbnail.

Examples of image features may include brisque score, whiteness, dullness, resolution, average pixel width, noise, sharpness, RGB values, face (present or not), face ratio, age, gender, human emotion, or text (present or not), of the thumbnail. The human emotion may be detected by an emotion detection model deployed within or outside the server 10. The face ratio could be defined as the ratio of actual face area (such as the streamer's face) to the total thumbnail area. The image features may be detected/determined/extracted by the thumbnail classifying unit 332 or by another image feature extraction unit.

The user classifying unit 330 is configured to classify or to determine if a user (or a viewer) is engaged or disengaged. The user classifying unit 330 may store the determination result as the engagement tag in the user DB 312. The user classifying unit 330 may refer to the behavior parameters and/or the attributes in the user DB 312 and make the determination according to their corresponding thresholds.

For example, determining a user to be disengaged may include one or more of the following steps: determining a view frequency of the user to be less than a frequency threshold, determining an average view duration of the user to be less than a view duration threshold, determining an average gift sending times of the user to be less than a gift number threshold, determining an average number of comments of the user to be less than a comment number threshold, determining a recency of the user to be greater than a recency threshold, and determining an engagement ratio of the user to be less than an engagement ratio threshold.

The threshold values may be determined according to actual practice, purpose, or experimental result. In some embodiments, a new user who joins the platform within a predetermined time period is tagged as disengaged. A disengaged user is considered to be inactive on the platform, and the platform (or server of the platform) does not have enough information about the user to perform recommendations based on preference matching. In some embodiments, if a user is not disengaged, the user will be classified as engaged. The platform can utilize past behavior data of an engaged user to recommend thumbnails (or live streams) based on preference matching.

The thumbnail classifying unit 332 is configured to classify or to determine if a thumbnail of a live stream is attractive for a user (or users) or not. The term “attractive” means there is a high probability the user will click the thumbnail to view the corresponding live stream. In some embodiments, the thumbnail classifying unit 332 may classify a thumbnail as generally attractive or not, which means the thumbnail is attractive to general users.

In some embodiments, the thumbnail classifying unit 332 refers to the user DB 312 and the thumbnail DB 336 to determine if a thumbnail is attractive for a particular user. For example, the thumbnail classifying unit 332 may input the behavior parameters and/or the attributes of a user (from the user DB 312), and the click rate, the click attributes, and/or the image features of a thumbnail (from the thumbnail DB 336), into the ML model 350. The ML model 350 then determines the attractiveness of the thumbnail for the user. The attractiveness could be a likelihood of the user clicking the thumbnail. The thumbnail classifying unit 332 may label the thumbnail as attractive for the user if a result provided by the ML model 350 shows there is a high probability the user will click the thumbnail.

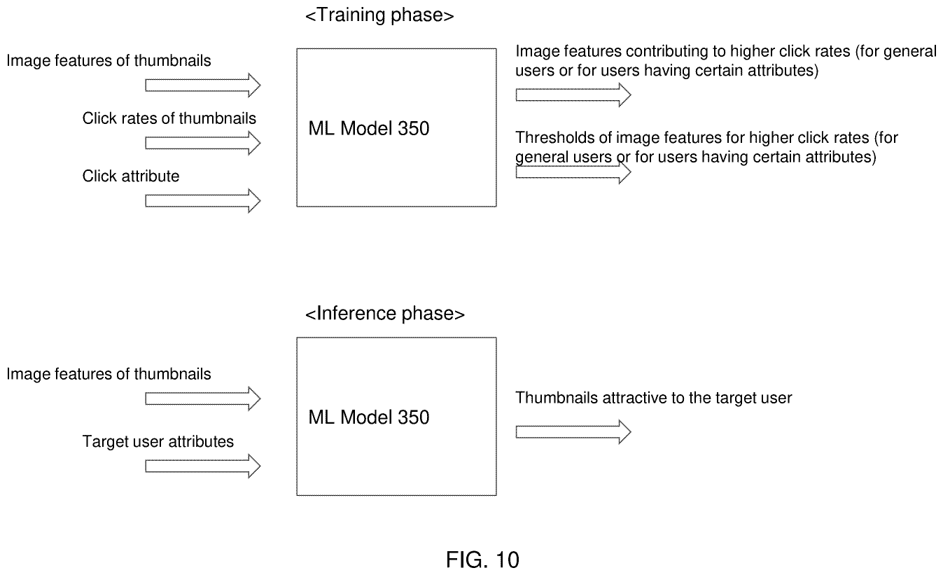

FIG. 10 shows an example of the ML model 350 in FIG. 3 according to some embodiments of the present disclosure. In some embodiments, the ML model 350 could be implemented within the server 10.

At the training phase, image features of thumbnails, click rates of each thumbnail, and click attributes of each thumbnail are input into the ML model 350. The ML model 350 then learns and delivers the image features that contribute to higher click rates. Or, the ML model 350 learns and delivers the image features that have higher impacts on click rates. With the click attribute data, the ML model 350 can learn and deliver the image features that contribute to or result in higher click rates for users (such as disengaged users) of a particular attribute (or particular attributes). The ML model 350 may deliver or determine thresholds (or types, tags) for those image features, such that, when one or more of the image features meet their corresponding thresholds (or types, tags), the corresponding thumbnail can have high click rates (or high chances to be clicked) for users having one or more particular attributes.

For example, the ML model 350 may learn that the image features [face ratio], [gender] and [human emotion] have higher impacts on the click rates for users having the attributes [gender=male] and [nationality=asia countries]. For example, the ML model 350 may learn that when [face ratio>70%], [gender=female] and [human emotion=sad], the corresponding thumbnail has a higher chance for users having the attributes [gender=male] and [nationality=asia countries] to click in.

At the inference phase, image features of thumbnails and attributes of one or more users are input into the ML model 350. The ML model 350 then determines which thumbnail is attractive to which user(s) (or which thumbnail is likely to be clicked by which user).

For example, for a user (or target user) with the attributes [gender=male] and [nationality=asia countries], the ML model 350 may determine or label a thumbnail with the image features [face ratio>70%], [gender=female] and [human emotion=sad] as attractive for the user.

In some embodiments, the ML model 350 has been trained with [image features of thumbnails of available live streaming programs] and [click rates of the thumbnails] to generate a threshold for each image feature contributing to higher click rates. In some embodiments, utilizing the click attribute data in the training process of the ML model 350 indicates that a great portion of clicks of thumbnails corresponding to (or having) the higher click rates are contributed by other users (or other disengaged users) having the same attributes as the target disengaged user. In some embodiments, the ML model 350 may incorporate algorithms such as random forest, gradient boost, xg boost and/or soft voting classifier.

The live stream classifying unit 334 is configured to classify or to determine if a live stream (or contents of a live stream) is attractive for a user (or users) or not. The term “attractive” means that, after clicking into the thumbnail corresponding to the live stream, there is a high probability the user will stay in the live stream (or chat room, or channel) for a predetermined time length. The time length could be, for example, 5 mins, 10 mins or longer. In some embodiments, the live stream classifying unit 334 may classify a live stream as generally attractive or not, which means the live stream is attractive to general users or not. The live stream classifying unit 334 may refer to the audience parameters and/or viewer IDs in the stream DB 310 and make the determination according to their corresponding thresholds.

For example, determining a live stream to be attractive for a user or for general users may include one or more of the following steps: determining an average number of comments per viewer of the live stream to be more than a comment number threshold, determining an average number of gifts per viewer of the live stream to be more than a gift number threshold, determining an average deposit amount per viewer of the live stream to be more than a deposit amount threshold, and determining a number of live viewers of the live stream to be more than a viewer number threshold.

The threshold values may be determined according to actual practice, purpose, or experimental result. In some embodiments, the threshold values may be determined such that, when one or more of the audience parameters meet the corresponding thresholds, the corresponding live stream can have higher retention rate (or viewer retention rate) or retention time (or viewer retention time) for users who enter the live stream. In some embodiments, the threshold values may be determined by a ML model (such as the ML model 350) utilizing historical audience parameters and the corresponding viewer retention rates or viewer retention time of live streams.

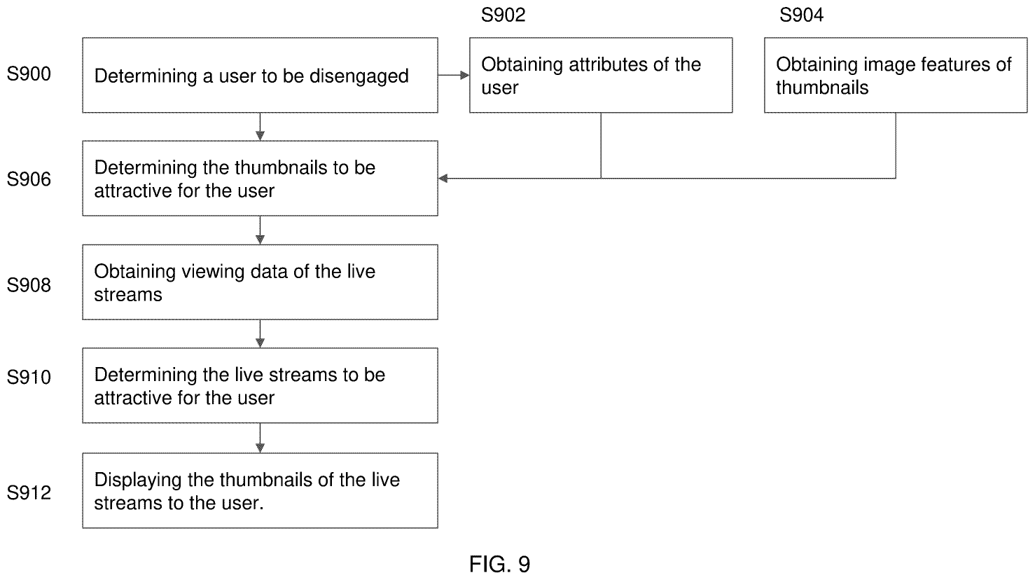

FIG. 9 shows an exemplary flow chart illustrating a method according to some embodiments of the present disclosure.

In step S900, a user is determined to be disengaged, by the user classifying unit 330, for example. The engagement tag corresponding to the user in the user DB 312 is marked as “disengaged”. That means the platform (or server of the platform) does not have enough information about the user to perform recommendations based on preference matching. The user classifying unit 330 may refer to the behavior parameters and/or the attributes in the user DB 312 and make the determination according to their corresponding thresholds, as described above.

In step S902, attributes of the user are obtained, from the user DB 312, for example. The attributes may be input by the user or detected by a detecting unit, and stored in the user DB 312.

In step S904, image features of thumbnails (each corresponding to a live stream) are obtained, from the thumbnail DB 336, for example. The image features may be detected/determined/extracted by the thumbnail classifying unit 332 or by another image feature extraction unit, and stored into the thumbnail DB 336.

In step S906, one or more thumbnails are determined to be attractive for the user, by the thumbnail classifying unit 332, for example. The thumbnail classifying unit 332 may input the image features of the thumbnail, and attributes of the user, into the ML model 350. The thumbnail classifying unit 332 may label the thumbnail as attractive for the user according to a result provided by the ML model 350, as the inference phase described above for the ML model 350. For example, the thumbnail classifying unit 332 may label the thumbnail as attractive for the user when determining the image features of the thumbnail to have met the corresponding thresholds with respect to the attributes of the user.

In step S908, viewing data of the live streams (which correspond to the thumbnails labeled as attractive for the user) are obtained, from the stream DB 310, for example. The viewing data may include the distributor IDs, the viewer IDs, and the audience parameters of the live streams.

In step S910, one or more live streams are determined to be attractive for the user, by the live stream classifying unit 334, for example. The live stream classifying unit 334 may refer to the audience parameters in the stream DB 310 and make the determination according to their corresponding thresholds, as described above.

In step S912, the thumbnails, which are (1) determined to be attractive for the user (step S906) and (2) correspond to live streams determined to be attractive for the user (step S910) are displayed to the user.

In some embodiments, the live stream classifying unit 334 determines the live stream to be attractive for the user around or right before the timing of displaying the thumbnail of the live stream to the user. For example, the stream classification may be done in a real time manner or in a periodical manner. The corresponding thumbnail may be displayed to the user as soon as the corresponding live stream is determined to be attractive for the user. That may improve the retention time or retention rate after the user clicks into the live stream. The recommendation precision may be improved by the real time classification because the popularity state (or the popularity state with respect to a specific user) of a live stream may change with time.

In some embodiments, the thumbnail classifying unit 332 may determine a thumbnail to have reached a click rate threshold contributed by other users (or other disengaged users) having the same attributes as the target user. The live stream classifying unit 334 may further determine a portion (for example, over a percentage threshold) of those other users (or other disengaged users) to have spent a predetermined time period (or over a retention time threshold) in the live stream corresponding to the thumbnail after they click the thumbnail. That can improve the recommendation precision.

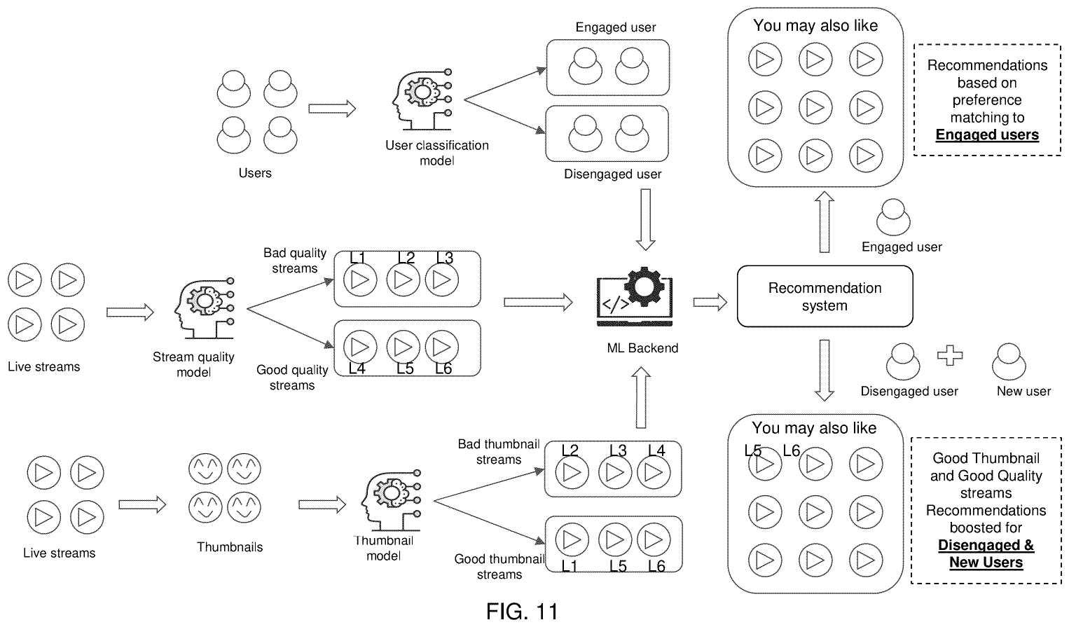

FIG. 11 shows an exemplary recommendation method according to some embodiments of the present disclosure.

As shown in FIG. 11, users or viewers are classified into engaged users and disengaged users by the user classification model. The user classification model could be the user classifying unit 330, and may utilize similar classification methods. Live streams are classified into bad quality streams (including L1, L2 and L3) and good quality streams (including L4, L5 and L6) by the stream quality model. The stream quality model could be the live stream classifying unit 334, and may utilize similar classification methods. Thumbnails of the live streams are classified into good thumbnails (with higher click rates, for example) and bad thumbnails (with lower click rates, for example) by the thumbnail model. The thumbnail model could be the thumbnail classifying unit 332, and may utilize similar classification methods. According to the thumbnail classification results, live streams are classified into live streams with bad thumbnails (including L2, L3 and L4) and live streams with good thumbnails (including L1, L5 and L6).

The user classification results, the live stream quality classification results, and the live stream thumbnail classification results are input into the ML backend for determining the recommendation strategy. The ML backend may include or may be the ML model 350. The determined recommendation strategy is passed to and executed by the recommendation system, which could be deployed within or outside the server 10. In this embodiment, recommendations to the engaged users are based on preference matching because the recommendation system (or the server 10) already has enough of their behavioral data. Recommendations to the disengaged users and new users are presented such that live streams which have good quality and good thumbnails (L5, L6) are ordered with higher priority (which could be called “boosted” in some embodiments). That can motivate the disengaged users and new users to click in the thumbnails and to stay longer in the live streams.

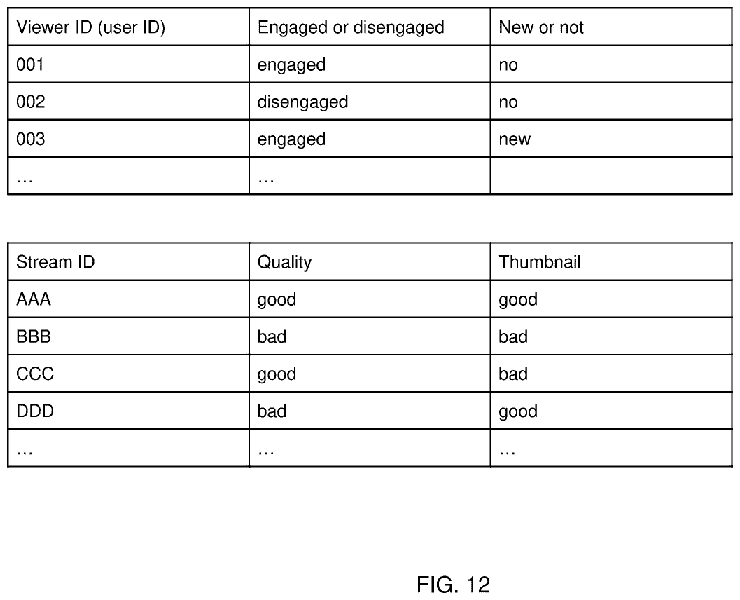

FIG. 12 shows examples of data structure for the classification results in FIG. 11. As shown in FIG. 12, each user is classified as engaged or disengaged, and is classified as new user or not. Each stream is classified as good quality or bad quality, and is classified as having good thumbnail or bad thumbnail.

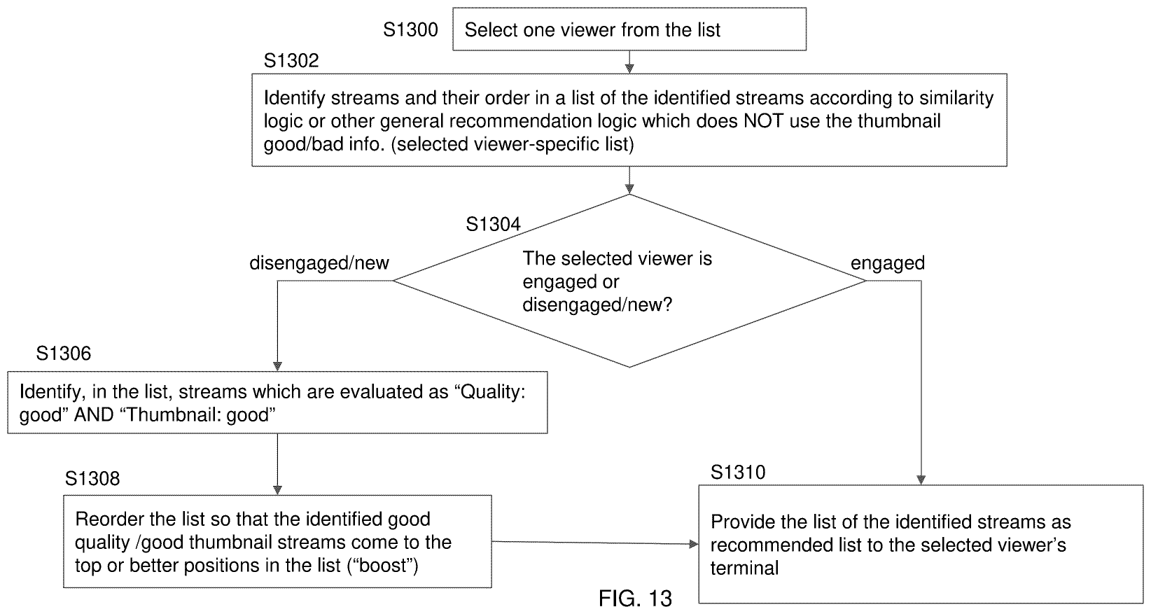

FIG. 13 shows exemplary processes executed by the recommendation system in FIG. 11 according to some embodiments of the present disclosure.

At step S1300, the recommendation system selects one viewer from the user list or user DB.

At step S1302, the recommendation system identifies streams and their order in a list of the identified (or available) streams according to similarity logic, preference matching or other general recommendation logic which does not use the thumbnail good/bad information. The list of streams is specific to the selected viewer. The similarity logic, preference matching or other general recommendation logic could be done with tags/attributes of streams and behavior/attributes of the viewer.

At step S1304, the recommendation system checks if the selected viewer is engaged or disengaged/new from information received from the ML backend. If the user is disengaged/new, the flow goes to step S1306. If the user is engaged, the flow goes to step S1310.

At step S1306, the recommendation system identifies, in the list of streams, streams which are evaluated as “Quality: good” AND “Thumbnail: good”.

At step S1308, the recommendation system reorders the list of streams so that the identified good quality/good thumbnail streams come to the top or better positions in the list (which could be called as a “boost” action).

At step S1310, the recommendation system provides the list of the identified streams as the recommended list to the selected viewer's terminal.

In some embodiments, at step S1306, the recommendation system can identify streams which are evaluated as “Quality: good” OR “Thumbnail: good”. In some embodiments, one or more streams with at least one of the quality and thumbnail being good is identified. In some embodiments, the recommendation strategy (or the recommended content) for engaged users is different from that for disengaged users. In some embodiments, disengaged viewers and new viewers may receive the same recommendation list.

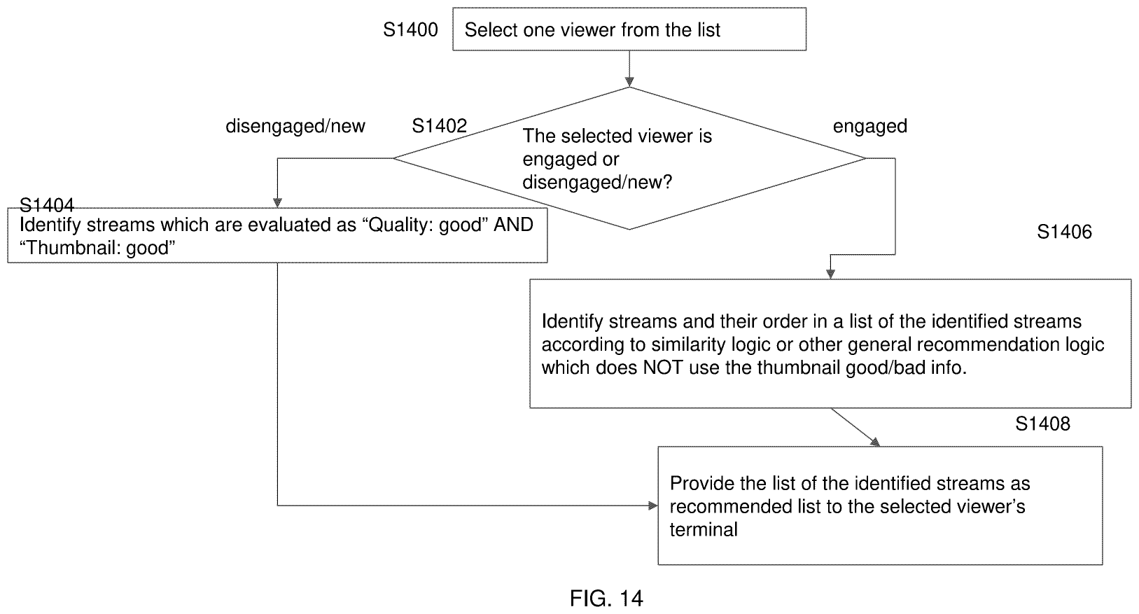

FIG. 14 shows exemplary processes executed by the recommendation system in FIG. 11 according to some embodiments of the present disclosure.

At step S1400, the recommendation system selects one viewer from the user list or user DB.

At step S1402, the recommendation system checks if the selected viewer is engaged or disengaged/new from information received from the ML backend. If the user is disengaged/new, the flow goes to step S1404. If the user is engaged, the flow goes to step S1406.

At step S1404, the recommendation system identifies streams which are evaluated as “Quality: good” AND “Thumbnail: good”.

At step S1406, the recommendation system identifies streams and their order in a list of the identified (or available) streams according to similarity logic, preference matching or other general recommendation logic which does not use the thumbnail good/bad information. The similarity logic, preference matching or other general recommendation logic could be done with tags/attributes of streams and behavior/attributes of the viewer.

At step S1408, the recommendation system provides the list of the identified streams as the recommended list to the selected viewer's terminal.

In some embodiments, at step S1404, the recommendation system can identify streams which are evaluated as “Quality: good” OR “Thumbnail: good”. In some embodiments, one or more streams with at least one of the quality and thumbnail being good is identified. In some embodiments, the recommendation strategy (or the recommended content) for engaged users is different from that for disengaged users. In some embodiments, disengaged viewers and new viewers may receive the same recommendation list. In some embodiments, the ML backend and the recommendation system could be integrated into one unit.

The present disclosure can improve the click rate for the thumbnails recommended to a disengaged user. The present disclosure can improve the retention rate or retention time for live streams corresponding to the thumbnails recommended to and clicked by a disengaged user. Traditional recommendation methods cannot reach the recommendation effect due to lack of information for disengaged users.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

### LIST OF REFERENCE NUMBERS

1 communication system
10 server
20 user terminal
30, 30a, 30b user terminal
LV distributor
AU1, AU2 viewer
VD, VD1, VD2 video image
NW network
30 user terminal
100 distribution unit
102 image capturing control unit
104 audio control unit
106 video transmission unit
108 distributor-side UI control unit
200 viewing unit
202 viewer-side UI control unit
204 superimposed information generation unit
206 input information transmission unit
302 distribution information providing unit
304 relay unit
306 gift processing unit
308 payment processing unit
310 stream DB
312 user DB
314 gift DB
330 user classifying unit
332 thumbnail classifying unit
334 live stream classifying unit
336 thumbnail DB
350 ML model
880 stream selection screen
TH1, TH2, TH3 Thumbnail
S900, S902, S904, S906, S908, S910, S912 step

What is claimed is:

1. A method for recommending live streams, comprising:
determining a user to be disengaged;
determining a thumbnail of a live stream to be attractive for the user;
determining the live stream to be attractive for the user; and
displaying the thumbnail of the live stream to the user.

2. The method according to claim 1, wherein the determining the user to be disengaged comprises at least one of the following steps:
determining a view frequency of the user to be less than a frequency threshold,
determining an average view duration of the user to be less than a view duration threshold,
determining an average gift sending times of the user to be less than a gift number threshold,
determining an average number of comments of the user to be less than a comment number threshold,
determining a recency of the user to be greater than a recency threshold, and
determining an engagement ratio of the user to be less than an engagement ratio threshold.

3. The method according to claim 1, wherein the determining the thumbnail of the live stream to be attractive for the user comprises:
extracting image features of the thumbnail;
inputting the image features of the thumbnail into a machine learning model; and labeling the thumbnail as attractive for the user according to a result provided by the machine learning model.

4. The method according to claim 3, wherein the machine learning model has been trained with image features of thumbnails of available live streams and click rates of the thumbnails to generate a threshold for each image feature contributing to higher click rates, and the labeling process includes determining the image features of the thumbnail to meet their corresponding thresholds.

5. The method according to claim 4, wherein a portion of clicks of thumbnails corresponding to the higher click rates are contributed by other disengaged users having the same attributes as the user.

6. The method according to claim 1, wherein the determining the live stream to be attractive for the user comprises at least one of the following steps:
determining an average number of comments per viewer of the live stream to be more than a comment number threshold,
determining an average number of gifts per viewer of the live stream to be more than a gift number threshold,
determining an average deposit amount per viewer of the live stream to be more than a deposit amount threshold, and
determining a number of live viewers of the live stream to be more than a viewer number threshold.

7. The method according to claim 6, further comprising:
determining the live stream to be attractive or the user around a timing of displaying the thumbnail of the live stream to the user.

8. The method according to claim 1, further comprising:
determining the thumbnail of the live stream to have reached a click rate threshold contributed by other disengaged users having the same attributes as the user;
determining a portion of the other disengaged users to have spent a predetermined time period in the live stream.

9. The method according to claim 5, wherein the attributes include gender, nationality, hobby, blood type or zodiac sign.

10. A system for recommending live streams, comprising one or a plurality of processors, wherein the one or plurality of processors execute a machine-readable instruction to perform:
determining a user to be disengaged;
determining a thumbnail of a live stream to be attractive for the user;
determining the live stream to be attractive for the user; and
displaying the thumbnail of the live stream to the user.

11. A non-transitory computer-readable medium including a program for recommending live streams, wherein the program causes one or a plurality of computers to execute:
determining a user to be disengaged;
determining a thumbnail of a live stream to be attractive for the user;
determining the live stream to be attractive for the user; and
displaying the thumbnail of the live stream to the user.

12. The method according to claim 8, wherein the attributes include gender, nationality, hobby, blood type or zodiac sign.
